(19) United States
(12) Patent Application Publication
(10) Pub. No.: US 2024/0201340 A1
(43) Pub. Date: Jun. 20, 2024

(54) LIDAR MODULE

(71) Applicant: Cloud Light Technology Limited, Hong Kong (HK)

(72) Inventors: Xian Wen Feng, Dongguan (CN); Chong Yang Qin, Dongguan (CN)

(21) Appl. No.: 18/175,517

(22) Filed: Feb. 27, 2023

(30) Foreign Application Priority Data
Dec. 16, 2022 (CN) 202211637909.9

(51) Int. Cl. G01S 7/481; G02B 7/02; G02B 26/08; G02B 26/10; H01F 7/08

(52) U.S. Cl. CPC G01S 7/4817; G02B 7/021; G02B 26/0875; G02B 26/10; H01F 7/081

(57) ABSTRACT

A lidar module includes a laser transceiver assembly configured to transmit and receive at least one laser beam and a lens scanning assembly integrated with the laser transceiver assembly. The lens scanning assembly has a movable lens arranged on an optical path of the laser beam transmitted by the laser transceiver assembly. The movable lens is configured with a way of movement in which the movable lens moves in a plane perpendicular to an optical axis of the movable lens to adjust a deflection direction of the laser beam. The present invention is intended to provide a lidar module, which can resolve a defect of a small detection field of view (FOV) of a lidar and realize modularization and miniaturization of a lens scanning assembly and a lidar.

### TECHNICAL FIELD

The present invention relates to the field of detection technologies, and in particular, to a lidar module.

### BACKGROUND

A lidar may obtain related parameters such as a target distance and a speed by transmitting a laser beam (single line/multi-line) to a target, comparing a reflected signal with the transmitted signal, and analyzing a return time (TOF) or a frequency difference (a Doppler shift) of the signal. For example, a planimetric map may be obtained through obstacle information reflected by one line beam laser through a plane, and a three-dimensional map may be obtained through obstacle information reflected by a plurality of laser beams through different planes.

With the continuous development of technologies such as smart driving and smart robots, increasingly high requirements are imposed on costs, a volume, and power consumption of a lidar which is used as a core sensor of the technologies. However, conventional mechanical scanning way (such as scanning through rotation of a plane mirror) has disadvantages such as a large volume, high power consumption, and poor reliability. Therefore, some concepts about a solid state lidar, such as an optical phased array, gradually emerged. However, a photon integration technology and a control algorithm corresponding to the optical phased array have no significant breakthroughs, and the technology is currently staying in the laboratory. A hybrid solid-state lidar such as a micro electro mechanical system (MEMS) micro vibrating mirror, although small in size after packaging, has a limited optical aperture and a limited scanning angle which limit a ranging ability and a field of view (FOV) of the MEMS micro vibrating mirror, and requires splicing of a plurality of sub-fields of view to obtain a large FOV, which imposes high requirements on a point cloud splicing algorithm and point cloud stability. Moreover, a cantilever beam structure of the MEMS micro vibrating mirror has poor impact resistance and reliability.

### SUMMARY

In view of the problems in the prior art, the present invention is intended to provide a lidar module, which can solve a defect about a small detection field of view (FOV) of a lidar and realize modularization and miniaturization of a lens scanning assembly and a lidar.

According to an embodiment of the present invention, a lidar module includes a laser transceiver assembly configured to transmit and receive at least one laser beam and a lens scanning assembly integrated with the laser transceiver assembly. The lens scanning assembly has a movable lens arranged on an optical path of the laser beam transmitted by the laser transceiver assembly. The movable lens is configured with a way of movement in which the movable lens moves in a plane perpendicular to an optical axis of the movable lens to adjust a deflection direction of the laser beam.

According to an embodiment of the present invention, the lens scanning assembly further includes a stationary lens that is stationary relative to a position of the laser transceiver assembly. The transmitted laser beam successively passes through the stationary lens and the movable lens. The movable lens moves relative to the stationary lens in the way of movement.

According to an embodiment of the present invention, the stationary lens is fixed to a first support, the first support has support bosses and a metal plate on a first surface, and the first surface faces the movable lens. The movable lens is fixed to a second support, a plurality of magnets arranged around the movable lens are fixed to a second surface of the second support, and the second surface is pressed against the support bosses through an interaction force between the magnets and the metal plate. The first surface further has a plurality of energized coils surrounding the stationary lens, and the movable lens moves relative to the stationary lens in the way of movement through an interaction force between the magnets and the energized coils.

According to an embodiment of the present invention, the energized coils are exposed from the first surface, and the metal plate is arranged inside the first support.

According to an embodiment of the present invention, the magnets are fixed in the second support, and the energized coils are fixed in the first support.

According to an embodiment of the present invention, the magnets are separated from the energized coils by the support bosses in a pressing direction.

According to an embodiment of the present invention, the movement includes translation and rotation.

According to an embodiment of the present invention, the laser transceiver assembly includes a plurality of laser transmitting units configured to transmit at least one laser beam simultaneously or at intervals, and each of the laser transmitting units transmits one laser beam.

According to an embodiment of the present invention, the laser transceiver assembly and the lens scanning assembly are accommodated in the same housing for integration.

According to an embodiment of the present invention, the housing includes a first metal shell and a second metal shell assembled together.

According to the present invention, the deflection direction of the optical path of the laser transmitted by the laser transceiver assembly is adjusted through the movable lens of the lens scanning assembly, so as to achieve scanning. In this way, a defect about a small detection FOV of a lidar can be resolved, and modularization and miniaturization of a lens scanning assembly and a lidar can be realized.

### BRIEF DESCRIPTION OF THE DRAWINGS

Aspects of the present invention may be understood most effectively from the following detailed description when read in combination with the drawings. It should be noted that, according to the standard practices in the industry, components are not drawn to scale. In fact, for clarity of description, sizes of the components may be increased or decreased randomly.

FIG. 1 is a three-dimensional view of a lidar module according to an embodiment of the present invention.

FIG. 2 is a schematic exploded view of the lidar module according to an embodiment of the present invention.

FIG. 3 is an enlarged view of a region A in FIG. 2.

FIG. 4 is a schematic exploded view of a lens scanning assembly according to an embodiment of the present invention.

FIG. 5 is a front view of a lens scanning assembly according to an embodiment of the present invention.

FIG. 6a and FIG. 6b are left views of the lens scanning assembly according to an embodiment of the present invention.

FIG. 7a is a front view corresponding to FIG. 3, and FIG. 7b and FIG. 7c are schematic diagrams of the lens scanning assembly in states different from that in FIG. 7a.

FIG. 7d shows a multi-angle laser beam that can be realized by the lens scanning assembly according to an embodiment of this application, and FIG. 7e is a three-dimensional view corresponding to FIG. 7d.

FIG. 8a shows an embodiment different from that in FIG. 7a, and FIG. 8b is a three-dimensional view corresponding to FIG. 8a.

FIG. 9a is a three-dimensional view of a set of energized coil and magnet, and FIG. 9b and FIG. 9c are cross-sectional views taken along a line A-A in FIG. 9a.

### DETAILED DESCRIPTION

The following disclosure provides a plurality of different embodiments or examples for implementing different features of the provided subject matter. Specific examples of elements and arrangements are described below to simplify the present invention. Certainly, these examples are not intended to limit the present invention. For example, in the following description, forming a first component above or on a second component may include an embodiment that the first component is in direct contact with the second component, or may include an embodiment that an additional component is formed between the first component and the second component such that the first component may not be in direct contact with the second component. In addition, in various examples of the present invention, reference numbers and/or letters may be repeated. The repetition is merely for simplicity and clarity and does not indicate a relationship between the various embodiments and/or configurations that are discussed.

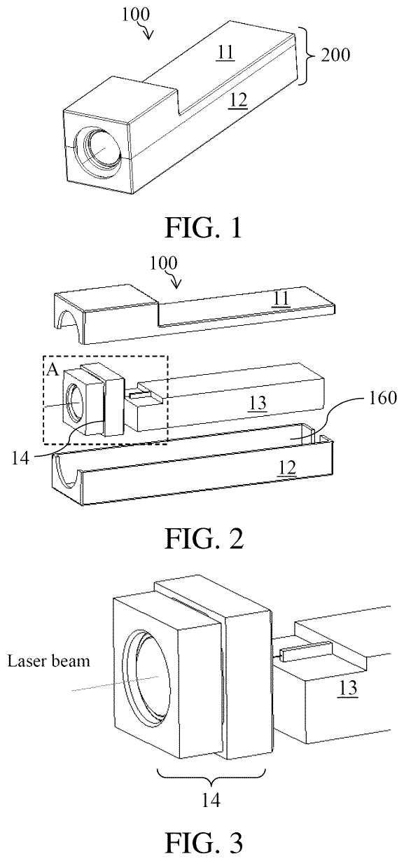

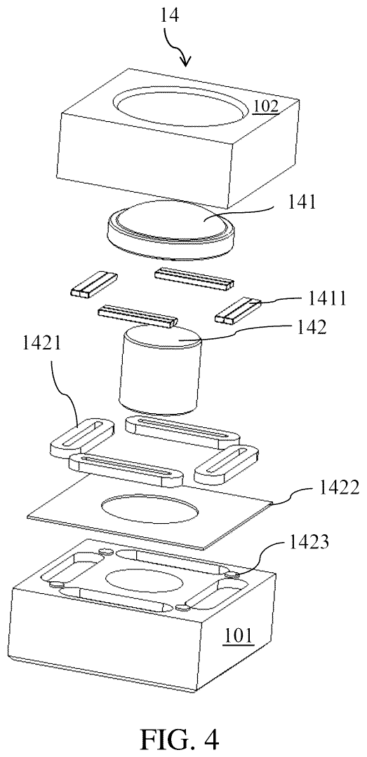

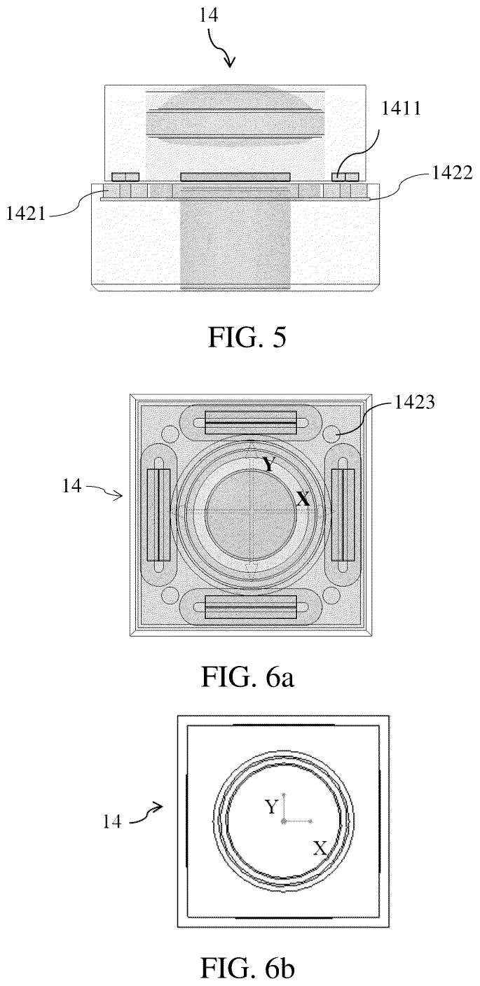

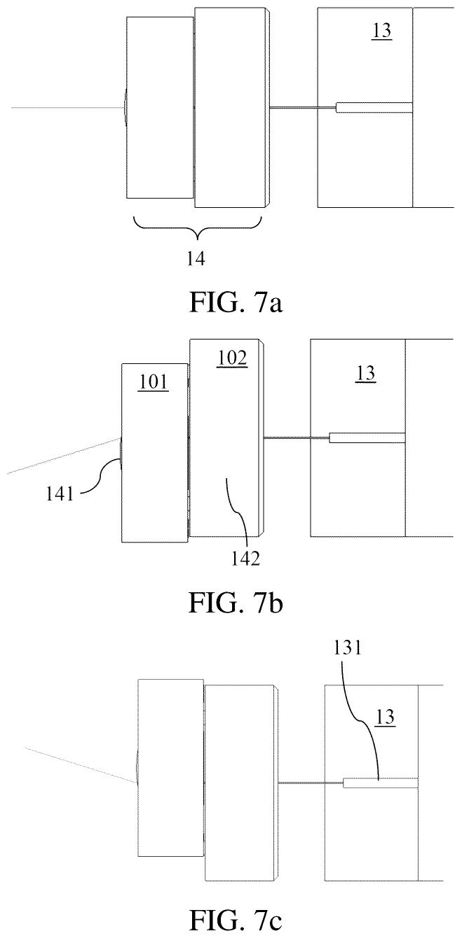

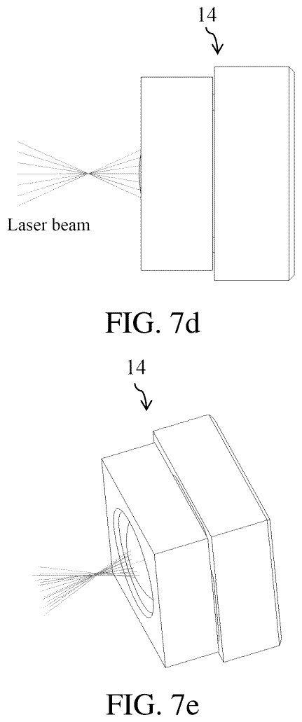

FIG. 1 is a three-dimensional view of a lidar module 100 according to an embodiment of the present invention. FIG. 2 is a schematic exploded view of the lidar module 100 according to an embodiment of the present invention. FIG. 3 is an enlarged view of a region A in FIG. 2, with an invisible structure shown by a thinner line. FIG. 4 is a schematic exploded view of a lens scanning assembly 14 according to an embodiment of the present invention. FIG. 5 is a front view of the lens scanning assembly 14 according to an embodiment of the present invention. FIG. 6a and FIG. 6b are left views of the lens scanning assembly 14 according to an embodiment of the present invention, with invisible structures (internal structures) shown by thinner lines in FIG. 4 to FIG. 6a. FIG. 7a is a front view corresponding to FIG. 3, and FIG. 7b and FIG. 7c are schematic diagrams of the lens scanning assembly 14 in states different from that in FIG. 7a. FIG. 7d shows a multi-angle laser beam that can be realized by the lens scanning assembly 14 according to an embodiment of this application, and FIG. 7e is a three-dimensional view corresponding to FIG. 7d.

The present invention provides a lidar module 100. The lidar module has a laser transceiver assembly 13 configured to transmit and receive at least one laser beam and a lens scanning assembly 14 integrated with the laser transceiver assembly 13. The lens scanning assembly 14 has a movable lens 141 arranged on an optical path of the laser beam transmitted by the laser transceiver assembly 13. The movable lens 141 is configured with a way of movement in which the movable lens moves in a plane perpendicular to an optical axis of the movable lens 141 (a plane XY shown in FIG. 6a and FIG. 6b) to adjust a deflection direction of the laser beam. According to the present invention, the deflection direction of the optical path of the laser beam transmitted by the laser transceiver assembly 13 is adjusted through the movable lens of the lens scanning assembly 14, that is, the optical path of the laser beam is deflected to achieve scanning. In this way, a defect about a small detection field of view (FOV) of a lidar in the prior art can be resolved. Further, a quantity of the laser transmitting units and a detection number in the laser transceiver assembly 13 can be reduced, and the costs can be significantly reduced.

The lidar module 100 of the present invention can realize 3D scanning through the lens scanning assembly 14 even with only one laser beam. In addition, in the present invention, the lens scanning assembly 14 and the laser transceiver assembly 13 are integrated into a module, which realizes modularization and miniaturization of the lidar module 100.

In some embodiments, the laser transceiver assembly 13 includes at least a set of laser transmitting and receiving units configured to transmit a laser and receive and detect an optical return path after blocking by an obstacle. During operation, at least one laser is transmitted to calculate information such as a distance and a speed of the obstacle.

According to an embodiment of the present invention, the lens scanning assembly 14 further includes a stationary lens 142 that is stationary relative to a position of the laser transceiver assembly 13. The laser beam transmitted by the laser transceiver assembly 13 successively passes through the stationary lens 142 and the movable lens 141. The movable lens 141 moves relative to the stationary lens 142 in the way of movement (moving in the plane perpendicular to the optical axis of the movable lens 141).

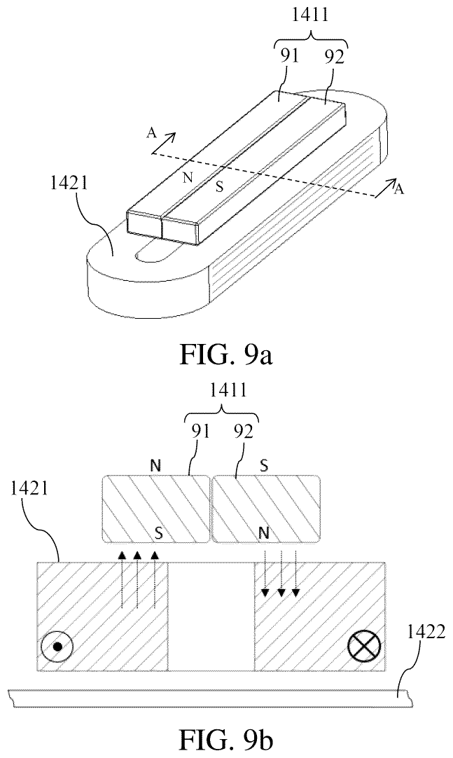

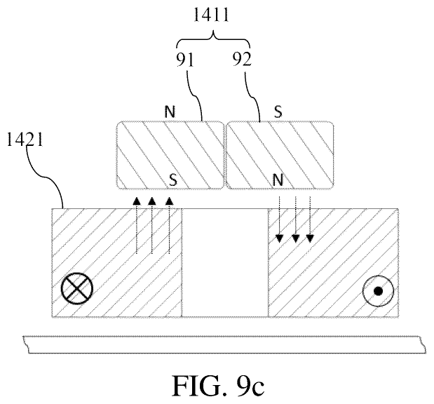

In some embodiments, as shown in FIG. 4, the stationary lens 142 is fixed to a first support 101, the first support 101 has support bosses 1423 and a metal plate 1422 on a first surface, and the first surface faces the movable lens 141. In some embodiments, the metal plate 1422 is embedded into the first support 101 through injection molding, or may be separately assembled on the first support 101. The metal plate 1422 may be exposed from the first surface of the first support 101 or located inside the first support 101. The movable lens 141 is fixed to a second support 102, a plurality of magnets 1411 arranged around the movable lens 141 are fixed to a second surface of the second support 102 facing the first surface, and the second surface is pressed against the support bosses 1423 through an interaction force between the magnets 1411 and the metal plate 1422. In some embodiments, the support bosses 1423 are configured to separate the second support 102 from the first support 101. The support bosses 1423 only need to be arranged between the second support and the first support, and may be assembled separately or integrated with related components. The first surface further has a plurality of energized coils 1421 surrounding the stationary lens 142, and the movable lens 141 moves relative to the stationary lens 142 in the way of movement through an interaction force between the magnets 1411 and the energized coils 1421, that is, moves in the plane perpendicular to the optical axis of the movable lens 141 to adjust the deflection direction of the laser beam. FIG. 9a is a three-dimensional view of a set of energized coil 1421 and magnet 1411. In some embodiments, the magnet 1411 includes a first portion 91 and a second portion 92 (the first portion 91 and the second portion 92 may be two independent magnets or may be one magnet). An upper surface of the first portion 91 is an N pole, and a lower surface is an S pole. An upper surface of the second portion is an S pole, and a lower surface is an N pole. Afield direction of the magnet 1411 is shown by an arrow. FIG. 9b and FIG. 9c are cross-sectional views taken along a line A-A in FIG. 9a, and additionally show a metal plate 1422 (such as, an iron sheet). The energized coil 1421 has different current directions in FIG. 9a and FIG. 9b. In some embodiments, the current direction of the energized coil 1421 is controlled through an external control circuit inside the first support 101. In FIG. 9a, a current flows in through a right side of the energized coil 1421 and flows out through a left side of the energized coil 1421, and the magnet 1411 moves rightward. In FIG. 9b, a current flows in through the left side of the energized coil 1421 and flows out through the right side of the energized coil 1421, and the magnet 1411 moves leftward. Through collaboration of four sets of energized coils 1421 and magnets 1411 shown in FIG. 4, movement of the movable lens 141 in the above way of movement is realized. In some embodiments, the energized coil 1421 and the magnet 1411 are replaced with other driving means such as a shape memory alloy (SMA) and piezoelectric ceramic (PZT).

As shown in FIG. 4, the energized coils 1421 are exposed from the first surface, and the metal plate 1422 is arranged inside the first support. In some embodiments, the metal plate 1422 is first embedded into the first support 101 through injection molding, and then the energized coils 1421 are assembled on the first support 101.

The magnets 1411 are fixed in the second support 102 (partially embedded, fully embedded, or attached to the surface of the second support 102), and the energized coils 1421 are fixed in the first support 101 (partially embedded, fully embedded, or attached to the surface of the first support 101).

In some embodiments, as shown in FIG. 5 and FIG. 6a, the magnets 1411 are separated from the energized coils 1421 by the support bosses 1423 in a pressing direction.

In some embodiments, the movement of the removable lens 141 includes translation and rotation. FIG. 7b shows downward translation of the removable lens 141 (the entire second support 102) relative to the stationary lens 142 (the second support 102). FIG. 7c shows upward translation of the removable lens 141 relative to the stationary lens 142.

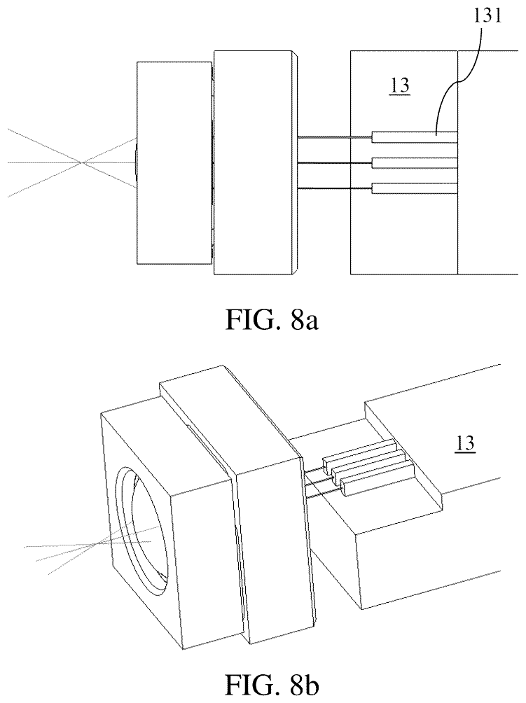

In some embodiments, the laser transceiver assembly 13 includes at least one laser transmitting unit 131. The laser transmitting unit 131 transmits one laser beam. In the embodiment shown in FIG. 7a to FIG. 7e, the laser transceiver assembly 13 includes one laser transmitting unit 131. FIG. 8a shows an embodiment different from that in FIG. 7a, and FIG. 8b is a three-dimensional view corresponding to FIG. 8a. In the embodiment shown in FIG. 8a and FIG. 8b, the laser transceiver assembly 13 includes a plurality of (three) laser transmitting units 131. The plurality of laser transmitting units 131 transmit at least one laser beam simultaneously or at intervals. Each of the laser transmitting units 131 transmits one laser beam. Compared to the embodiment in which one laser transmitting unit 131 is used, scanning efficiency can be significantly improved in the embodiment in which the plurality of laser transmitting units 131 are used.

The lidar module 100 of the present invention can realize 3D scanning through the lens scanning assembly 14 even with only one laser transmitting unit 131. Therefore, a quantity of the laser transmitting units 131 and a detection number can be reduced, and the costs can be significantly reduced. The scanning efficiency can be significantly improved if the plurality of laser transmitting units 131 are used.

In some embodiments, as shown in FIG. 1 and FIG. 2, the laser transceiver assembly 13 and the lens scanning assembly 14 are accommodated in the same housing 200 for integration. In some embodiments, the housing 200 includes a first metal shell 11 and a second metal shell 12 assembled together. The first metal shell 11 and the second metal shell 12 defines a cavity 160 configured to mount, secure, and protect the internal components such as the laser transceiver assembly 13 and the lens scanning assembly 14. The laser transceiver assembly 13 and the first support 101 are fixed in the housing 200, and the removable lens 141 is accommodated in the shell and is movable relative to the housing 200.

According to the lidar module 100 of the present invention, the lens scanning assembly 14 and the laser transceiver assembly 13 are integrated into a module, so that a volume can be reduced to a centimeter level, which facilitates miniaturization and standardization, and significantly improves the compatibility of the lidar module 100 with a whole system.

In addition, according to the present invention, the deflection direction of the optical path of the laser transmitted by the laser transceiver assembly 13 is adjusted through the movable lens 141 of the lens scanning assembly 14, to realize three-dimensional scanning. In this way, mechanical motion devices in a conventional scanning device such as a bulky motor are omitted, so that the system stability is improved, and the power consumption and the volume of the lidar module 100 can be reduced.

The above descriptions are merely preferred embodiments of the present invention and are not intended to limit the present invention. A person skilled in the art may make various modifications and changes to the present invention. Any modification, equivalent replacement, and improvement made within the spirit and principle of the present invention shall fall within the protection scope of the present invention.

What is claimed is:

1. A lidar module, comprising a laser transceiver assembly configured to transmit and receive at least one laser beam, wherein the lidar module further comprises:
a lens scanning assembly, integrated with the laser transceiver assembly, wherein the lens scanning assembly has a movable lens arranged on an optical path of a laser beam transmitted by the laser transceiver assembly; and
the movable lens is configured with a way of movement in which the movable lens moves in a plane perpendicular to an optical axis of the movable lens to adjust a deflection direction of the laser beam.

2. The lidar module according to claim 1, wherein the lens scanning assembly further comprises a stationary lens that is stationary relative to a position of the laser transceiver assembly;
the transmitted laser beam successively passes through the stationary lens and the movable lens; and
the movable lens moves relative to the stationary lens in the way of movement.

3. The lidar module according to claim 2, wherein
the stationary lens is fixed to a first support, the first support has support bosses and a metal plate on a first surface, and the first surface faces the movable lens;
the movable lens is fixed to a second support, a plurality of magnets arranged around the movable lens are fixed to a second surface of the second support, and the second surface is pressed against the support bosses through an interaction force between the magnets and the metal plate; and
the first surface further has a plurality of energized coils surrounding the stationary lens, and the movable lens moves relative to the stationary lens in the way of movement through an interaction force between the magnets and the energized coils.

4. The lidar module according to claim 3, wherein the energized coils are exposed from the first surface, and the metal plate is arranged inside the first support.

5. The lidar module according to claim 3, wherein the magnets are fixed in the second support; and
the energized coils are fixed in the first support.

6. The lidar module according to claim 3, wherein the magnets are separated from the energized coils by the support bosses in a pressing direction.

7. The lidar module according to claim 1, wherein the movement comprises translation and rotation.

8. The lidar module according to claim 1, wherein the laser transceiver assembly comprises a plurality of laser transmitting units configured to transmit at least one laser beam simultaneously or at intervals; and
each of the laser transmitting units transmits one laser beam.

9. The lidar module according to claim 1, wherein the laser transceiver assembly and the lens scanning assembly are accommodated in the same housing for integration.

10. The lidar module according to claim 9, wherein the housing comprises a first metal shell and a second metal shell assembled together.
